(19) United States
(12) Patent Application Publication
(10) Pub. No.: US 2012/0051329 A1
(43) Pub. Date: Mar. 1, 2012

(54) BASE STATION AND WIRELESS COMMUNICATION SYSTEM

(75) Inventors: Jun Hirano, Kanagawa (JP); Takashi Tamura, Kanagawa (JP); Takahisa Aoyama, Kanagawa (JP)

(73) Assignee: PANASONIC CORPORATION, Osaka (JP)

(21) Appl. No.: 13/254,243

(22) PCT Filed: Feb. 22, 2010
(86) PCT No.: PCT/JP2010/001123

§ 371 Date: Sep. 1, 2011

(30) Foreign Application Priority Data
Mar. 27, 2009 (JP) 2009-078313
Jan. 7, 2010 (JP) 2010-001763

(51) Int. Cl. H04W 36/30

(52) U.S. Cl. 370/332

(57) ABSTRACT

A base station 10 comprises a measurement report receiving unit 12 which receives a measurement report transmitted from a mobile terminal which is performing communication by using a plurality of bands through Band Aggregation; a handover determining unit 13 which determines whether or not handover is required, based on the measurement report; and a gap period setting unit 14 which, if it is determined that the handover is required, configures a gap period in which the communication is temporarily switched to a band different from a band in communication, in order to search for a band which is a destination of the handover. The gap period setting unit 14 also configures the gap period in the band in communication other than a band for which the measurement report is provided. Thereby, it is possible to provide the base station and the terminal in which effective configuration of the gap period is performed when the plurality of bands are used.

### RELATED APPLICATION

The present application claims the benefit of Japanese Patent Application No. 2009-078313, filed on Mar. 27, 2009, and Japanese Patent Application No. 2010-001763, filed on Jan. 7, 2010, whose contents are incorporated herein by reference.

### TECHNICAL FIELD

The present invention relates to a base station which controls a Band Aggregation (also referred to as “Carrier Aggregation”)-enabled terminal.

### BACKGROUND ART

In recent years, a standards organization 3GPP advances standardization of LTE-Advanced (hereinafter referred to as “LTE-A”) as a next generation wireless communication standard compatible with LTE. In LTE-A, introduction of Band Aggregation is considered in which a mobile terminal uses a plurality of carrier frequencies of one base station. The Band Aggregation is a technique in which the mobile terminal uses a plurality of component carriers to improve throughput.

FIG. 9 is a diagram showing a summary of the Band Aggregation. In an example shown in FIG. 9, an example is shown in which the terminal uses two component carriers having carrier frequencies f1 and f3, in three component carriers (having carrier frequencies f1, f2 and f3). In this way, throughput in communication between the terminal and the base station is expected to be improved by using the plurality of component carriers.

A Band Aggregation capable mobile terminal can also perform handover (hereinafter, “HO”) between different frequencies. In this case, in order to select an HO destination, configuring for measurement of the different frequency becomes important. This point will be described below.

Also in the Band Aggregation, the base station determines whether or not to perform the HO, based on a measurement report transmitted from the mobile terminal, and if the HO is performed, the base station indicates the HO to the mobile terminal. The mobile terminal performs quality measurement based on measObject (Measurement Object) indicating a measurement object determined for each frequency by the base station, and if measurement result satisfies a set condition, the mobile terminal transmits the measurement report to the base station.

Generally, for the HO destination, the same frequency as a frequency of a currently connected cell is prioritized as the measurement object. The measurement of the different frequency may often be performed if there is no HO destination satisfying the condition at the same frequency.

Incidentally, in order to perform the measurement of the different frequency, communication of a currently used carrier needs to be temporarily interrupted. This period in which resources for data communication are not assigned is referred to as “gap period”. Even if the different frequency has been described as a measurement parameter in the measObject indicating the measurement object, the measurement of the different frequency cannot be started in a state where the gap period has not been configured. Accordingly, the mobile terminal is configured the gap period for the measurement of the different frequency by the base station.

The base station performs provision of the gap period periodically, and the like, to enable the mobile terminal to collect necessary information. In this period, since at least a receiver of the mobile terminal switches to a frequency different from a frequency in current communication, the communication between the mobile terminal and the base station in communication is stopped. Consequently, the base station does not assign the resource for data communication during the period in which the measurement is performed, and instructs the mobile terminal to perform the quality measurement. It should be noted that each indication to perform the quality measurement is not explicit, and the quality measurement may also be performed based on a previously configured condition. Furthermore, a non-communication period in discontinuous transmission and reception (in which the non-communication period is provided for the purpose of lower power consumption or the like) can also be used for the measurement of the different frequency, similarly to the gap period (or as the gap period).

### CITATION LIST

### Non Patent Literature

Non Patent Literature 1: 3GPP TS36.331 v8.4.0 “Evolved Universal Terrestrial Radio Access (E-UTRA) Radio Resource Control (RRC)”
Non Patent Literature 2: 3GPP T536.300 v8.7.0 “Evolved Universal Terrestrial Radio Access (E-UTRA) and Evolved Universal Terrestrial Radio Access Network (E-UTRAN); Overall description; Stage 2”
Non Patent Literature 3: 3GPP TS25.331 v8.5.0 “Radio Resource Control (RRC); Protocol specification”
Non Patent Literature 4: 3GPP T536.321 v8.4.0 “Evolved Universal Terrestrial Radio Access (E-UTRA); Medium Access Control (MAC) protocol specification”

### SUMMARY OF INVENTION

### Technical Problem

As described above, since the communication cannot be performed in the gap period for performing the measurement of the different frequency, it is predicted that a delay is caused in the communication and also retransmission control is affected. While performance is less impact in a functional block which is relatively highly tolerant of the delay at an application level or the like, a delay of retransmitted data impacts performance (a data error rate and an intermediate data discard rate) or the like in retransmission control in a short time in HARQ (Hybrid ARQ) or the like.

FIGS. 10 and 11 are diagrams showing statuses where a problem associated with data communication and the gap period occurs. First, the mobile terminal detects the need for the different frequency measurement. For the need for the different frequency measurement, it is judged that the quality measurement of the different frequency is required, for example, in cases (1) where communication quality becomes degraded or congested in one or more currently used frequencies (a cell configured by a certain base station) and a situation occurs where the resource assignment cannot be sufficiently performed; (2) where the quality measurement of another cell at the same frequency with a relatively low processing load of the handover is attempted as a priority of the handover, however, a cell satisfying necessary quality cannot be detected at the same frequency; and the like. The mobile terminal starts a procedure for measuring a frequency other than the frequency at which the communication quality is degraded. It should be noted that the frequency other than the degraded frequency may also be a cell in a different access network (RAT: Radio Access Technology).

In an example shown in FIG. 10, the need for measuring the different frequency f2 is detected due to the degraded communication quality of the frequency f1. The mobile terminal performs the quality measurement of an Inter-frequency (the different frequency)/an Inter-RAT (a different RAT in 3G). First, the base station configures the gap period and issues the quality measurement indication. In response to this indication, the mobile terminal switches the frequency in the gap period to perform the quality measurement. The mobile terminal returns to the original frequency, and when all the necessary information is collected, the mobile terminal transmits a Measurement Report (MR) to the base station. If the information required for the report has not been able to be sufficiently measured, the periodic gap period is configured. The mobile terminal returns to a data communication state once, and then performs the quality measurement of the different frequency again. In the example shown in FIG. 10, the mobile terminal performs the measurement of the frequency f2 twice.

In the gap period, the resources for the communication (transmission and reception) are not assigned. Accordingly, the resources cannot be assigned to retransmitted data for data transmitted and received immediately before the gap period, until the mobile terminal returns to the original frequency. Thereby, the retransmitted data frequently arrives at the mobile terminal late or is frequently transmitted late from the mobile terminal. This causes the delay in the data transmission and reception as well as transmission and reception of response signals (Ack/Nack), and also the degradation in the performance, particularly for the HARQ whose performance is closely related to earliness of a retransmission cycle.

FIG. 11 is a diagram describing an operation of the HARQ. First, the HARQ will be described. The HARQ is a retransmission control method which provides feedback sooner relative to retransmission according to RLC and is executed in an MAC layer and a PHY layer. In the HARQ, transmitted signals are combined at a receiver to reduce errors. On a down-link, a retransmission timing is notified, and the retransmission is performed while a transmission method is changed (this is referred to as “asynchronous-adaptive”). Specifically, in the HARQ, a likelihood of received data is calculated, and if the likelihood is smaller than a predetermined threshold, the received data is stored in a buffer and also the retransmission of the data is prompted. When the data is retransmitted, the received data is stored in the buffer and combined with previously received data, and the received data having a higher likelihood is obtained. This process is repeatedly performed until the likelihood becomes equal to or larger than the predetermined threshold. In the HARQ, a plurality of retransmission processes can be included in parallel.

Next, an effect which the gap period has on the operation of the HARQ will be described using FIG. 11. As shown in FIG. 11, in the HARQ, the same data is retransmitted until the data is correctly received. In the HARQ, the retransmitted data is received more than once until the likelihood of the received data becomes equal to or larger than the predetermined threshold. If the likelihood of the received data becomes equal to or larger than the threshold before the gap period, the HARQ process is completed at that time point. However, if there is the gap period during the data retransmission, the operation of the HARQ is interrupted. The retransmitted data stored in the buffer until then may be flushed in the gap period. If the retransmitted data stored in the buffer is flushed, the data reception must be resumed from the beginning, which leads to worse data reception efficiency.

It is also possible to keep the data in the buffer during the gap period. However, power consumption for keeping the data occurs. In the HARQ, the received data (for example, the data including the likelihood) before a data string is determined is stored and the reception is repeatedly performed. Thus, the power consumption becomes larger relative to retention of a determined data string itself.

Immediately after the gap period is ended, the transmitted data may be concentrated (at a sender), and a congestion state may occur for the assignment of the resources for the transmission. Generally, in the congestion state, processing efficiency is significantly reduced relative to a normal state. Accordingly, the delay of the transmitted data can happen to appear as a delay larger than the delay only for the gap period.

At a time point when the concentration (remaining) of the transmitted data due to the delay is not completely eliminated, if a next gap period is started, there is also concern that an effect of the concentration (remaining) of the transmitted data gradually increases to affect a higher layer. Specifically, transmission in the higher layer might be failed.

If an upper limit of a number of times of the HARQ retransmission which is configured by the base station side is relatively large, whereas an interval of gap periods is configured short, a wait time (set by a timer) can expire before the number of times of the retransmission reaches the upper limit, due to increase in the above described delay. In this case, since the HARQ process sequentially fails and the data in the buffer is flushed each time, a state can also occur where the communication is actually disabled. In some cases, a retransmission procedure is required in the higher layer.

In view of the above described background, an object of the present invention is to provide a base station and a terminal in which effective configuration of the gap period is performed when a plurality of bands are used.

### Solution to Problem

A base station of the present invention comprises a measurement report receiving unit which receives a measurement report transmitted from a mobile terminal which is performing communication by using a plurality of bands through Band Aggregation; a handover determining unit which determines whether or not handover is required, based on the measurement report; and a gap period setting unit which, if it is determined that the handover is required, temporarily interrupts the communication in a band in communication and configures a gap period, in order to search for a band which is a destination of the handover, wherein the gap period setting unit also configures the gap period in the band in communication other than a band for which the handover is determined to be required.

### Advantageous Effects on Invention

According to the present invention, the gap period is configured not only in the band for which the handover is required, but also in another band in communication. Thus, the gap periods are dispersed across the plurality of bands, which provides an advantageous effect that an effect of the communication interrupt due to the gap period can be reduced.

As described below, there are other aspects of the present invention. Accordingly, in the disclosure of the present invention, it is intended to provide a part of the present invention, and it is not intended to limit the scope of the invention described and claimed herein.

### BRIEF DESCRIPTION OF DRAWINGS

FIG. 1 is a diagram showing a configuration of a wireless communication system of a first embodiment.

FIG. 2 is a diagram showing a communication status where three frequencies f1, f2 and f3 are used.

FIG. 3 is a diagram showing an example of configuring gap periods for measuring reception quality.

FIG. 4 is a diagram showing a variation of configuring the gap periods.

FIG. 5 is a diagram showing a variation of configuring the gap periods.

FIG. 6 is a diagram showing a configuration of the wireless communication system of a fourth embodiment.

FIG. 7 is a diagram showing a timing of transmitting request information to a base station 10.

FIG. 8 is a diagram showing association between an up-link and a down-link.

FIG. 9 is a diagram showing a summary of Band Aggregation.

FIG. 10 is a diagram showing a status where a problem associated with data communication and the gap period occurs.

FIG. 11 is a diagram showing a status where the problem associated with the data communication and the gap period occurs.

FIG. 12A is a diagram showing an example of a conventional signaling message.

FIG. 12B is a diagram showing a specific message example of signaling for explicitly indicating a gap configuration order.

FIG. 13 is a diagram showing an example of an operation of increasing a frequency of configuring a gap.

FIG. 14 is a diagram showing an example of a signaling message for realizing the operation of increasing the frequency of configuring the gap.

FIG. 15 is a diagram showing a summary of an operation of configuring the gap by using a CQI.

FIG. 16 is a diagram showing a summary of another operation of configuring the gap by using the CQI.

FIG. 17 is a diagram showing a configuration of the wireless communication system of a seventh embodiment.

### DESCRIPTION OF EMBODIMENTS

Hereinafter, the present invention will be described in detail. Embodiments to be described below are merely examples of the present invention, and the present invention can be varied in various aspects. Accordingly, particular configurations and functions to be disclosed below do not limit the claims.

Hereinafter, a base station and a terminal of an embodiment of the present invention will be described.

### First Embodiment

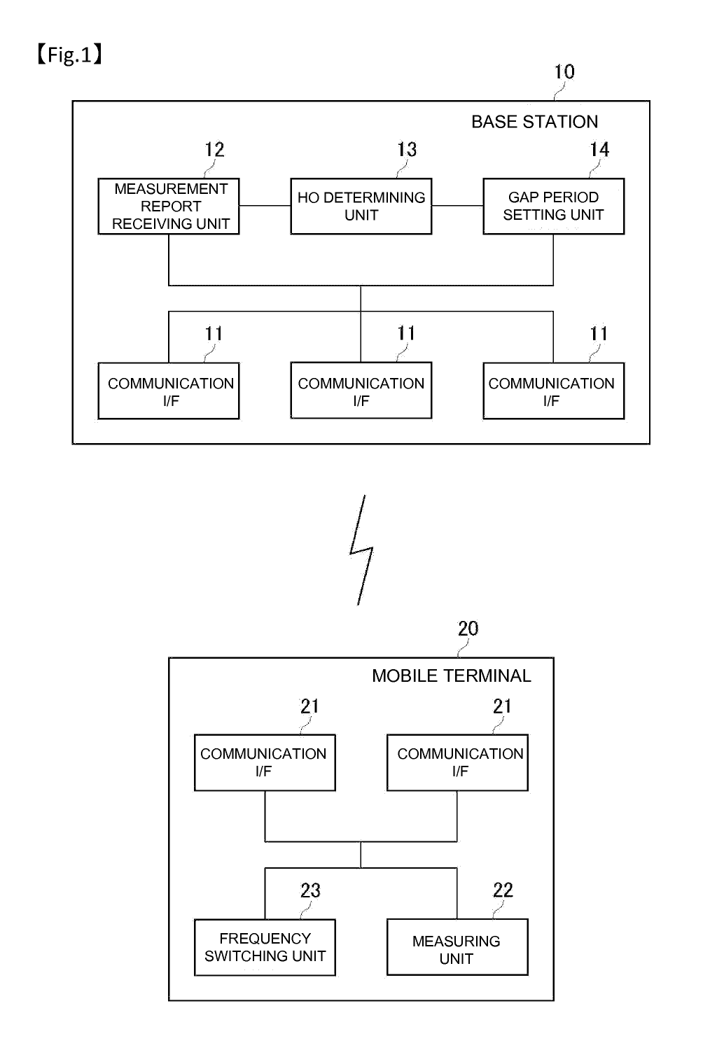

FIG. 1 is a diagram showing a configuration of a wireless communication system of a first embodiment. The wireless communication system has a base station 10 and a mobile terminal 20. The base station 10 has three communication interfaces 11 which perform communication at different frequencies, a measurement report receiving unit 12, a handover determining unit (hereinafter referred to as “HO determining unit”) 13, and a gap period setting unit 14.

The measurement report receiving unit 12 receives a measurement report transmitted from the mobile terminal 20, and passes the received measurement report to the HO determining unit 13. The HO determining unit 13 determines whether or not HO is required, based on the received measurement report. When reception quality of a frequency at which communication with the mobile terminal 20 is being performed becomes worse and it is determined that the HO is required, the gap period setting unit 14 configures another frequency whose reception quality should be measured, and a gap period for measuring the frequency. The gap period setting unit 14 transmits configuration information of gap period which has been configured, to the mobile terminal 20.

The mobile terminal 20 has two communication interfaces 21 which perform communication at different frequencies, a measuring unit 22 which measures the reception quality and transmits the measurement report, and a frequency switching unit 23 which switches the frequency to be measured in the measuring unit 22. The frequency switching unit 23 switches the frequency based on the configuration information of gap period transmitted from the base station 10.

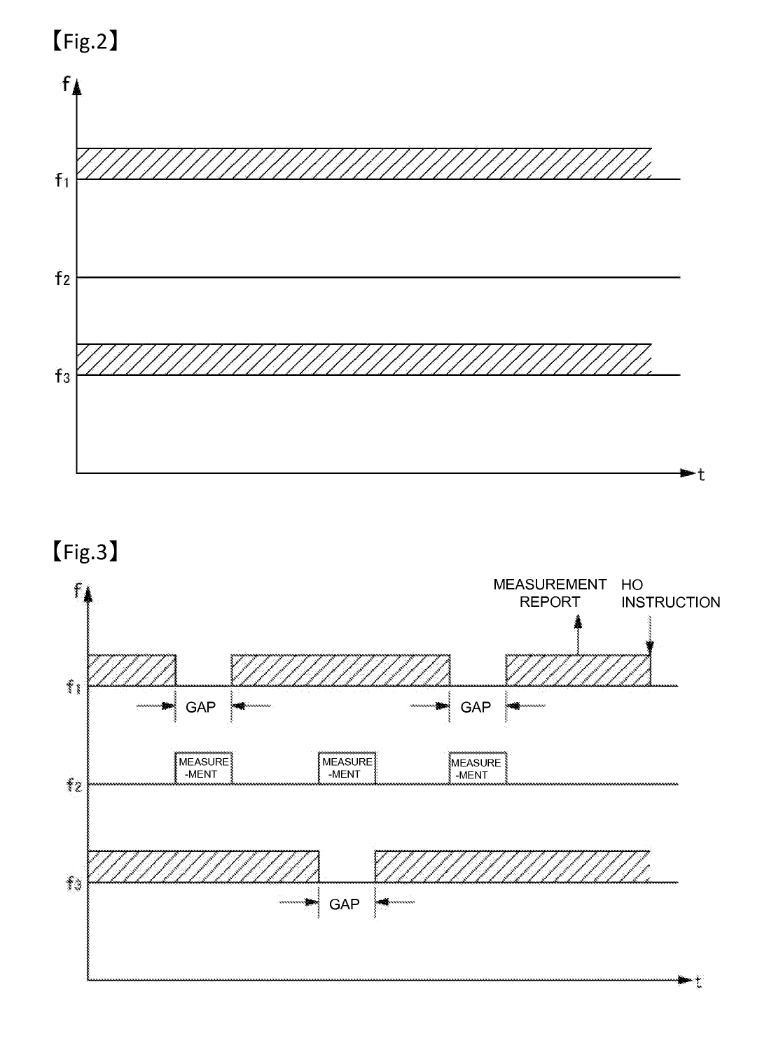

FIG. 2 is a diagram showing three frequencies f1, f2 and f3 which are available for Band Aggregation, and a communication status of the mobile terminal 20. Since the mobile terminal 20 has the two communication interfaces 21, the mobile terminal 20 can simultaneously use two frequencies in the three frequencies f1, f2 and f3 to perform the communication. In an example shown in FIG. 2, the mobile terminal 20 uses the frequencies f1 and f3 to perform the communication. Here, an operation in a case where the reception quality of the frequency f1 has become worse will be described.

If the reception quality of the frequency f1 has become worse in the communication with the base station 10 by using the frequencies f1 and f3, the mobile terminal 20 transmits the measurement report to the base station 10. If the base station 10 judges that the mobile terminal 20 needs to perform the quality measurement of a different frequency, the base station 10 checks whether or not the mobile terminal 20 is currently in a Band Aggregation state.

If the Band Aggregation is performed in different cells (mainly having different frequencies) within the same base station 10, the check is completed at the base station 10. However, in such a system in which the Band Aggregation is performed in cells provided by different base stations 10, signaling is separately required in order to check the Band Aggregation between the base stations 10.

If there is the cell in which the mobile terminal 20 performs the Band Aggregation, the base station 10 appropriately configures a frequency at which the gap period is configured and an arrangement of the gap period, along with the frequency to be measured. In other words, the base station 10 explores the possibility of configuring the gap period also at the frequency f3 other than the frequency f1 whose degradation in communication quality has been reported, and configures an optimal gap period. For the arrangement of the gap period, a specified period or any period can be configured in a specified cycle or at any timing. Particularly, if not only an operation of reception at the mobile terminal 20 but also an operation of transmission from the mobile terminal 20 stops due to the quality measurement of the different frequency, HARQ of transmitted data and HARQ of received data, as well as transmission and reception of Ack/Nack of those HARQs are also considered for the arrangement of the gap period.

The base station 10 notifies the mobile terminal 20 of the frequency at which the gap period is configured and configuration information of the gap period. This configuration information comprises, for example, a parameter related to the gap period, an instruction to perform the quality measurement of the different frequency, and information on which frequency the gap period is configured at, and the like. The transmission of the gap period configuration information from the base station 10 to the mobile terminal 20 may be performed through the frequency f3 at which the Band Aggregation is being performed, and which is different from the frequency f1 whose communication quality is degraded. The mobile terminal 20 configures the gap period according to the configuration information transmitted from the base station 10, and measures the reception quality of the frequency f2.

For a method of configuring the gap period and a gap position, in the current LTE (36.331) specification, a 40 ms cycle and an 80 ms cycle are prepared. In a case of the 40 ms cycle, values of 0 to 39 are indicated as gapOffset, and a gap start position is a subframe with gapOffset mod 10 in a radio frame having an SFN wherein the System frame number (SFN) mod 40=FLOOR (gapOffset/10). In a case of the 80 ms cycle, values of 0 to 79 are indicated as gapOffset, and the gap start position is a subframe with gapOffset mod 10 in the radio frame having the SFN wherein the System frame number (SFN) mod 40=FLOOR (gapOffset/10).

In this method, since there are a plurality of frequencies at which gaps should be configured, both the terminal and the base station need to know in what order the gaps are configured. For example, if the gap period is 40 ms, that is, if the gap period at the frequency f1 and the frequency f3 is 40 ms, it is conceivable to decide that, for the frequency f1, the gap is started from a subframe with gapOffset mod 10 in the radio frame having the SFN wherein the System frame number (SFN) mod 80=FLOOR (gapOffset/10), and that, for the frequency f3, the gap is started from another subframe with gapOffset mod 10 in the radio frame having the SFN wherein the System frame number (SFN) mod 40=FLOOR (gapOffset/10). This operation for explicitly notifying what order the gaps are configured in will be shown below.

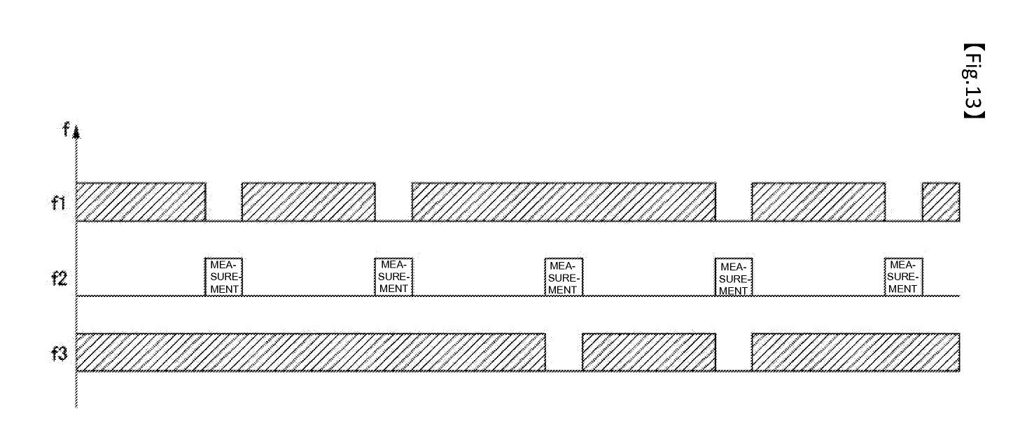

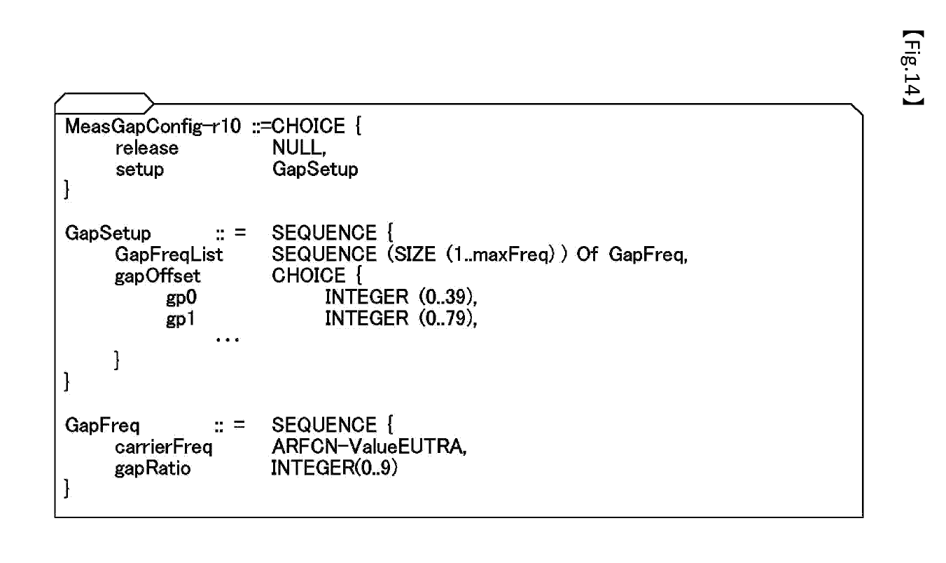

FIG. 12B is a diagram showing a specific message example of signaling for explicitly indicating a gap configuration order. FIG. 12A is a diagram showing an example of a conventional signaling message. As shown in FIG. 12A, when the gap is configured, “setup” is selected, and “gp0” is selected if a length of the gap is 40 ms, and “gp1” is selected in a case of 80 ms. The gap position is selected to be 0 to 39 if the length of the gap is 40 ms, and is selected to be 0 to 79 if the length of the gap is 80 ms. Next, with reference to FIG. 12B, the signaling message example of this example will be described. As shown in FIG. 12B, in the signaling message, the plurality of frequencies at which the gap should be configured is configured in “carrierFreqList”. The base station enters information on the frequencies into “carrierFreqList” according to the gap configuration order. For example, if the base station has entered the information into “carrierFreqList” in order of the frequency f1 and the frequency f3, an operation for configuring the gap at the frequency f1 first is performed. Conversely, if the base station has entered the information in order of the frequency f3 and the frequency f1, an operation for configuring the gap at the frequency f3 first is performed. “ARFCN-ValueEUTRA” is information indicating the frequency. There is one kind of the gap for each frequency, and the one kind of the gap is configured similarly to the example shown in FIG. 12A. Here, while an example of the signaling message is shown, the present invention is not limited to this message example, and similar control can also be performed by another method.

FIG. 3 is a diagram showing an example of configuring the gap periods for measuring the reception quality of the frequency f2 of the mobile terminal 20. In the example shown in FIG. 3, the gap period is configured at the frequency f1 to measure the reception quality of the frequency f2, and in addition, the gap period is also provided at the frequency f3 to measure the reception quality of the frequency f2. Normally, the gap period is configured at the frequency f1 for which it is determined that the HO is required, and the reception quality of the frequency f2 is measured. However, in the example shown in FIG. 3, since the gap period is also configured at the frequency f3, an interval at which the gap periods are arranged can be increased more than usual.

In the present embodiment, since the gap period is configured not only at the frequency f1 whose reception quality is degraded, but also at the frequency f3, the gap periods are dispersed across the plurality of frequencies. An effect which the gap period has on an HARQ process can be reduced at each frequency. Since the reception quality is not degraded in the frequency f3, the received data having a higher likelihood can be obtained at a smaller number of times of retransmission. Accordingly, in the frequency f3, data in a buffer for the HARQ process is less likely to be discarded due to the gap period.

The base station 10 and the wireless communication system of the first embodiment have been described above. In the above description, the example has been described in which the gap periods are alternately configured at the frequency f1 and the frequency f3. However, as the method of configuring the gap period, the gap period can be appropriately configured depending on various elements such as the reception quality of each frequency, the number of HARQ processes activated at each frequency, and an application being executed by using data being communicated at each frequency. Variations of configuring the gap period in consideration of the various elements will be described below.

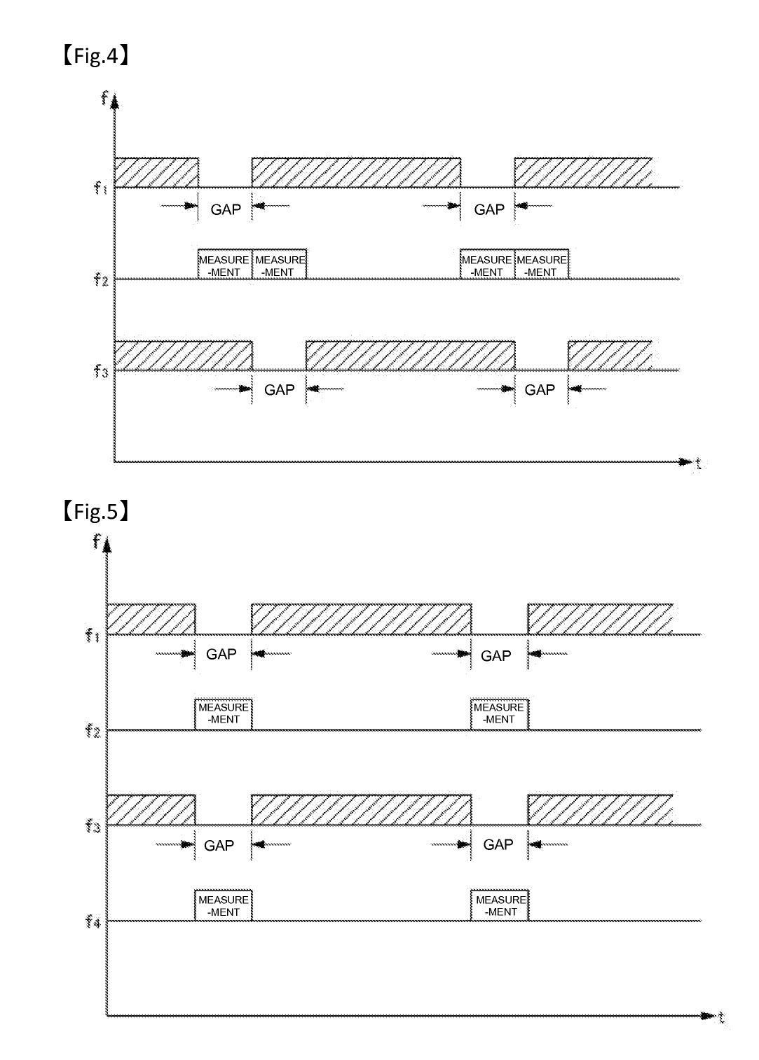

FIG. 4 is a diagram showing a variation of configuring the gap periods. In the above described embodiment, the gap period configured at the frequency f1 and the gap period configured at the frequency f3 are temporally separated from each other. However, as shown in FIG. 4, the gap periods may be configured to be temporally continuous so that one measurement period at the frequency f2 becomes longer. If a certain measurement time is required for searching for necessary information, the information can be efficiently searched for by increasing one measurement time. An example where the certain measurement time is required for searching for the necessary information is a case where, in a state where the mobile terminal 20 does not know a broadcast timing, the mobile terminal 20 must continue the measurement for a certain period until desired system information is broadcasted.

In the above described first embodiment, the case where the Band Aggregation is performed with the three frequencies is described as an example. However, the gap periods can be similarly configured to be dispersed also in a case where the Band Aggregation is performed with four or more frequencies. For example, if the Band Aggregation is performed with four frequencies f1 to f4, for example, the gap period for measuring the reception quality of the frequency f2 may be configured at the frequency f1, and the gap period for measuring the reception quality of the frequency f4 may be configured at the frequency f3.

FIG. 5 is a diagram showing an example of simultaneously configuring the gap periods for two different frequencies. In this way, if there are the plurality of frequencies f2 and f4 which are measurement objects, the gap periods at the frequencies f1 and f3 may be nearly simultaneously configured. The base station 10 indicates either single gap configuration or measurement of different frequency so that the mobile terminal can simultaneously perform the quality measurement of a plurality of different frequencies, and thus an amount of the signaling can be reduced.

If the mobile terminal 20 is performing the communication by using the three frequencies f1, f2 and f3, the gap periods for measuring the reception quality of the frequency f4 may be configured at the frequencies f1, f2 and f3 so that the interval between the gaps is three times as long as the interval in the case where the gap periods are configured at the single frequency f1.

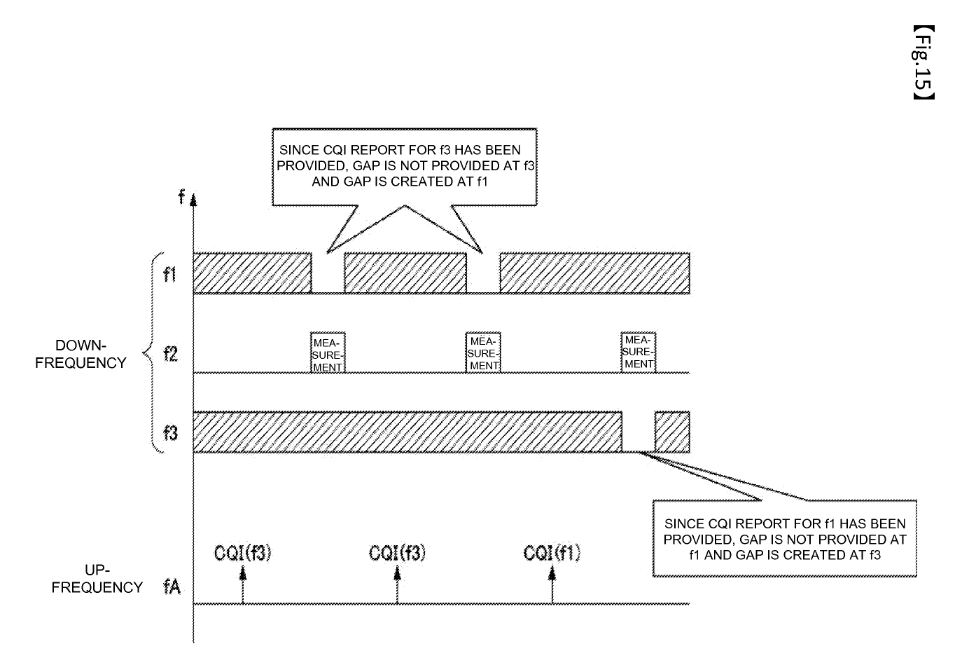

A frequency of providing the gap can also be changed for each frequency at which the gap is provided. For example, when the gap is provided at the frequencies f1 and f3, the gap configuration order can also be configured as the frequencies f1, f1, f3, f1, f1 and f3 so that a frequency of configuring the gap at the frequency f1 is increased. FIG. 13 is a diagram showing an example of an operation of increasing the frequency of configuring the gap, and FIG. 14 is a diagram showing an example of a signaling message for realizing the operation of increasing the frequency of configuring the gap. As shown in FIG. 14, the signaling message has a parameter of “gapRatio”, and the frequency of configuring the gap is designated in this parameter. In the example shown in FIG. 13, since the frequency f1:the frequency f3=2:1, “2” is designated for the frequency f1, and “1” is designated for the frequency f3.

Thereby, there is an advantageous effect that the number of gaps at the frequency f3 is reduced in a case where the quality of the frequency f1 is worse and the communication is desired to be performed by using the frequency f3 for a longer time, or the like. It should be noted that the present invention is not limited to this message example, and similar control can also be performed by another method.

In the above described embodiment, the example has been described in which the gap periods are configured to be dispersed across a plurality of bands. However, the gap periods do not necessarily need to be configured in all the bands. For example, if there are three bands in which the gap period can be configured, the gap period may be configured in two of the three bands, and the gap period may not be configured in the remaining one band. Thereby, the HARQ is enabled to be unaffected in the remaining one band.

The gap period can also be configured only at the frequency at which no degradation has occurred in the communication quality. In this method, the gap period is not configured at the frequency f1 whose communication quality is degraded, but the gap period is configured at the remaining frequency f3 side. Generally, a number of times of repeated transmission of the HARQ is smaller and the HARQ process is completed in a shorter time with better communication quality. Thus, even if the gap period occurs, the HARQ process is highly likely to be completed immediately before the occurrence of the gap period, or even if the HARQ process is interrupted, the HARQ process is highly likely to be immediately recoverable after the gap period is ended. An HARQ operation can be stabilized as much as possible by not configuring the gap period at the frequency f1 whose quality is degraded.

In the above described embodiment, a threshold may be configured so that an effect equal to or above a certain level may not occur in the communication at the frequency f1 whose reception quality is degraded, and the gap period may not be configured at an interval shorter than the threshold.

A normal method of configuring the gap period only at the frequency f1 whose communication quality is degraded, and the gap period configuring methods described in the present embodiment may be combined as appropriate. The base station 10 judges which method is efficiently used, and configures the gap period. For example, if a degree of the degradation of the frequency f1 whose communication quality is degraded is too large (below a predetermined threshold), a problem may already have occurred in maintenance itself of the communication. In this case, the gap periods may be configured to be concentrated at the frequency f1 in order to concentrate efforts on the quality measurement of the different frequency, instead of continuously performing the data communication to reduce a communication rate, using a part of communication cost for retransmission control, or increasing an error correction process.

In the above described embodiment, the case has been described where the degradation in the communication quality has occurred at the frequency f1. However, also if the quality of both the frequencies f1 and f3 has degraded, similarly to the above description, the configuring can be performed similarly to the above regarding whether to configure the gap periods at only one frequency and perform the quality measurement of the different frequency, or to configure the gap periods at both frequencies and perform the quality measurement of the different frequency, as well as the timing and the like.

While only any one of the above described gap period configuring methods can also be performed, the operation may be performed by switching among the gap period configuring methods depending on the degree of the quality degradation. For example, if the quality degradation has occurred only at the frequency f1 and the degree of the degradation is relatively light, the gap periods may be configured at the frequency f1 and the frequency f3. If the degree of the degradation is moderate, the gap periods may be configured only at the frequency f3. If the degree of the degradation is severe, the gap periods may be configured only at the frequency f1. Totally efficient communication can be performed by using the threshold to discriminate a state of the reception quality or the like, and switching the frequency at which the gap period is configured, depending on the state. The variations of configuring the gap period as described above are also applicable to second and subsequent embodiments to be described below.

In the above described embodiment, the measurement object may not be the frequency f2, but may also be the frequency f3 at which the Band Aggregation is performed (for example, see FIG. 3). The base station 10 may perform a process for checking whether or not the different frequency for which the quality measurement is required is the same as the frequency of the cell in which the Band Aggregation is performed. Thereby, if the frequency which is the object of the quality measurement is the same as the frequency at which the Band Aggregation is performed, it can be known that the frequency which is the measurement object has already been successfully used. Accordingly, sufficient information can be obtained through the quality measurement at the frequency which is already being used, without removing the frequency as a frequency of a handover destination from the object of the quality measurement, or configuring the gap period for the quality measurement of the different frequency.

### Second Embodiment

Next, the wireless communication system of the second embodiment of the present invention will be described. A basic configuration and operations of a second wireless communication system are the same as the first embodiment (see FIG. 1). In the second embodiment, a further more efficient operation is performed by considering a state of the HARQ in the mobile terminal 20 and reducing the effect on the HARQ process.

The mobile terminal 20 receives and checks the data transmitted from the base station 10, and transmits the Ack to a transmitter when a data transmission unit is determined. The mobile terminal 20 of the present embodiment knows that a corresponding HARQ process is completed when the data transmission unit is determined, and thus configures the gap period. When receiving the Ack transmitted from the mobile terminal 20, the base station 10 configures the gap period.

In the HARQ, if repeatedly received data is determined on the HARQ process, that is, if the repeatedly received data can be correctly received and is in a state where the repeatedly received data can be passed to a higher layer, the Ack is returned or a new data transmission unit is transmitted (including information indicating that the data transmission unit is the new data transmission unit) to the transmitter, and thereby, a next HARQ process is started. If the gap period is started during the repeated transmission of the HARQ and during response to the repeated transmission, it is conceivable that the interrupt of the HARQ process affects performance of the HARQ process. In the present embodiment, the gap period is configured at a time point when the HARQ process has just been completed. Thereby, the HARQ process itself can be prevented as much as possible from being segmented by the gap period, and thus the HARQ can be efficiently performed.

In the present embodiment, the base station 10 configures the gap period at a time point when the base station 10 has received the Ack (or at a time point when the HARQ process at the base station 10 has become OK and has been determined). However, the base station 10 may configures the gap period at another timing. For example, in a case where the data transmission unit is not determined (an error is not eliminated) on a receiver side even though a certain number of times of retransmission have been performed, if the mobile terminal 20 is a terminal which performs a process for passing the process to a next data transmission unit, the gap period may be configured after the certain number of times of retransmission.

In the above description, the description assumes that an effect of the interrupt due to the gap period on the HARQ process being performed on the mobile terminal 20 side is reduced. However, if the mobile terminal 20 is transmitting data to the base station 10, the gap period is configured so that the effect of the gap period on the HARQ process being executed at the base station 10 can be reduced. For example, the gap period may be configured in a band in which a small number of processes are being executed at the base station. Moreover, the gap period may be configured at a timing when the HARQ process at the base station has become OK.

### Third Embodiment

Next, the wireless communication system of a third embodiment of the present invention will be described. A basic configuration and operations of a third wireless communication system are the same as the first embodiment (see FIG. 1).

In the third embodiment, the gap period is configured at a frequency at which the HARQ process has been completed or which has received the Ack, at an earliest timing from a time point when the need for configuring the gap period has occurred. While the gap period is configured at any timing in the second embodiment, it is determined which band in the plurality of bands the gap period is configured in, in the present embodiment.

In the third embodiment, the gap period setting unit 14 of the base station 10 configures the gap period in a band which has first received the Ack transmitted from the mobile terminal 20, or a band which has performed a predetermined number of times of retransmission. Thereby, the gap period is configured in the band in which the HARQ process is completed, and thus the HARQ process is less likely to be interrupted. Moreover, even if the HARQ process is interrupted and the data stored in the buffer is discarded, a new HARQ process has just been started and an amount of data to be discarded is small. Thus, the effect of the interrupt is small.

The wireless communication system of the third embodiment configures the gap period based on the state of the HARQ process, similarly to the second embodiment. Thus, the HARQ process itself can be prevented as much as possible from being segmented by the gap period, and the HARQ can be efficiently performed.

In the wireless communication system of the third embodiment, since the timing of configuring the gap period is predetermined, there is an advantageous effect that there are few changes from conventional periodic configuration of the gap period. It should be noted that, at the frequency at which the gap period is configured, the states of the HARQ process are identical at both the transmission and the reception (the transmitter and the receiver of the data) at a nearly same timing (the HARQ process becomes OK: the Ack is received, which number of times of retransmission the data is retransmitted at, or the like). The determination can be desirably performed based on this judgment, without any special signaling between the base station and the mobile terminal.

### Fourth Embodiment

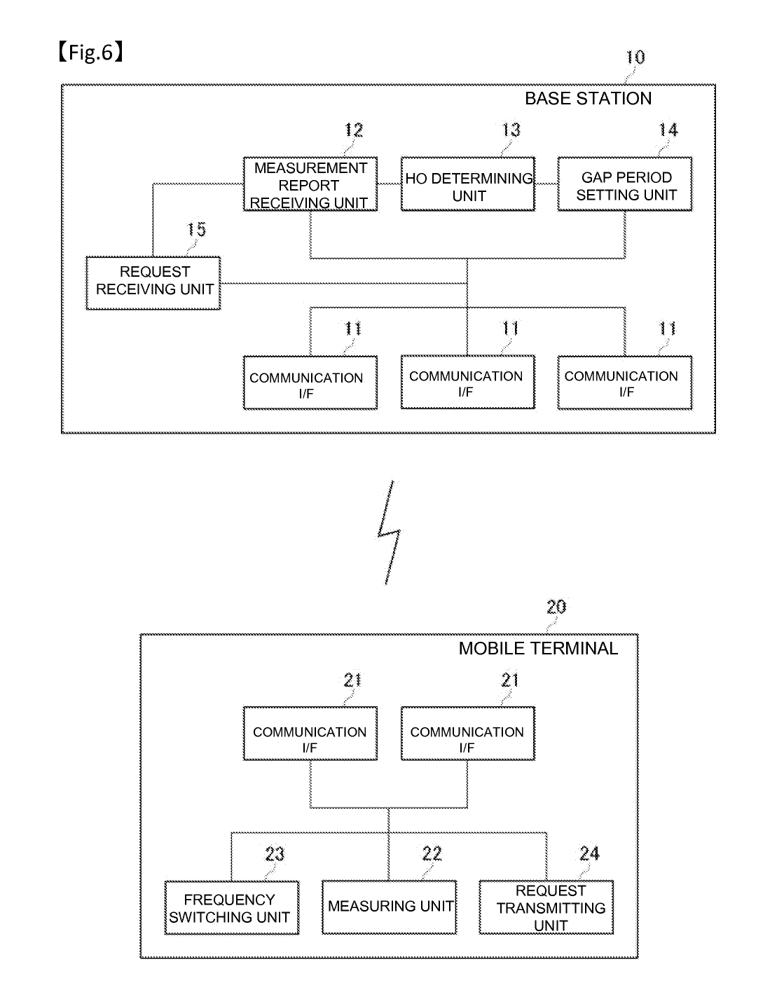

FIG. 6 is a diagram showing a configuration of the wireless communication system of a fourth embodiment. While the basic configuration of the wireless communication system of the fourth embodiment is the same as the wireless communication system of the first embodiment, the fourth embodiment is different in that the mobile terminal 20 transmits request information related to the configuration of the gap period, to the base station 10.

In addition to the configuration of the mobile terminal 20 of the first embodiment, the mobile terminal 20 of the fourth embodiment has a request transmitting unit 24 which transmits a request related to the gap period, to the base station 10. The request transmitting unit 24 obtains a frequency at which the gap period is requested to be configured, based on an application used in each band, a status of the HARQ, or the like, and transmits data indicating the frequency, as the request to the base station 10. The request transmitting unit 24 may transmit information for requesting a different frequency depending on a condition (that is, a gap period configuring rule), rather than simply the frequency at which the gap is requested to be configured.

The request transmitting unit 24 generates the request information indicating the frequency at which the gap period is configured, based on an application usage status or the status of the HARQ in the mobile terminal 20. For example, file downloading is tolerant of delay, whereas quality of a voice call is significantly degraded by an effect of the delay. If the voice call is performed at the frequency f1 and the file downloading is performed at the frequency f3, the request transmitting unit 24 may generate the request information for configuring the gap period at the frequency f3, and transmit the request information to the base station 10. Such information on the tolerance of the delay or the like is also reflected in a QoS parameter, and thus can also be judged with reference to the QoS parameter.

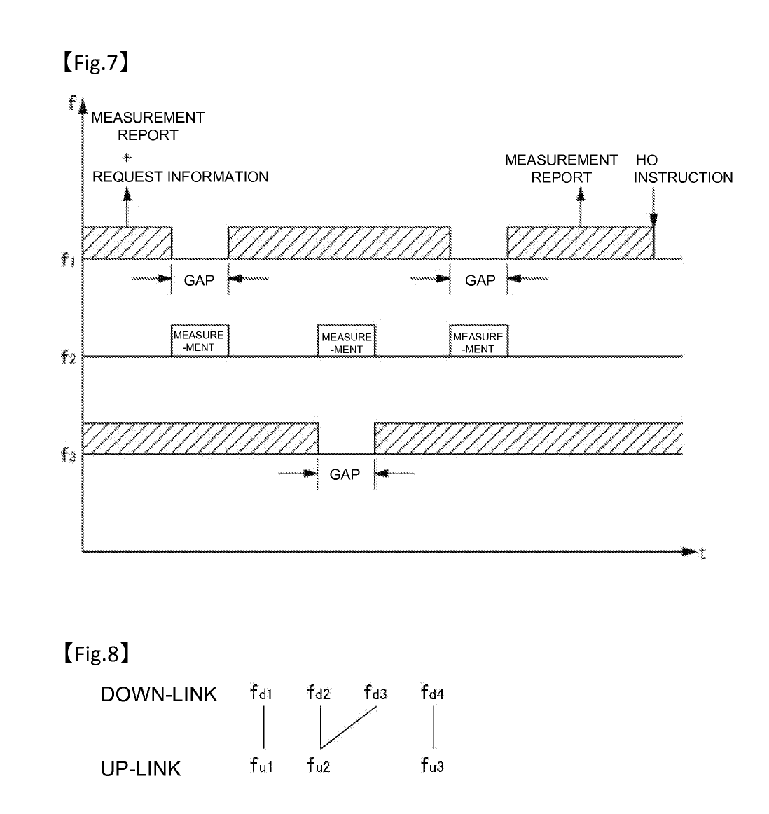

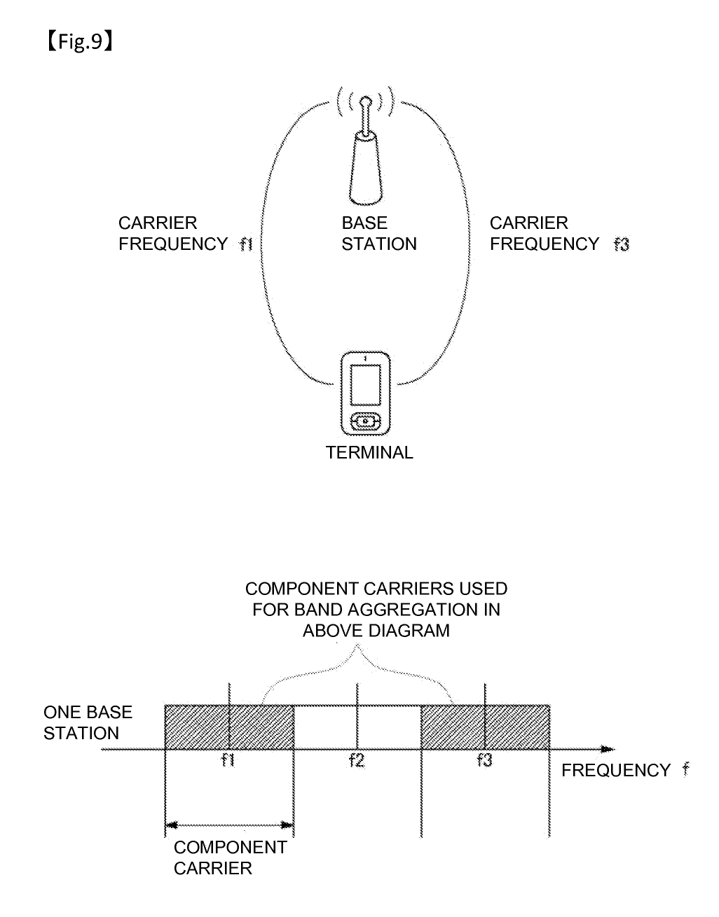

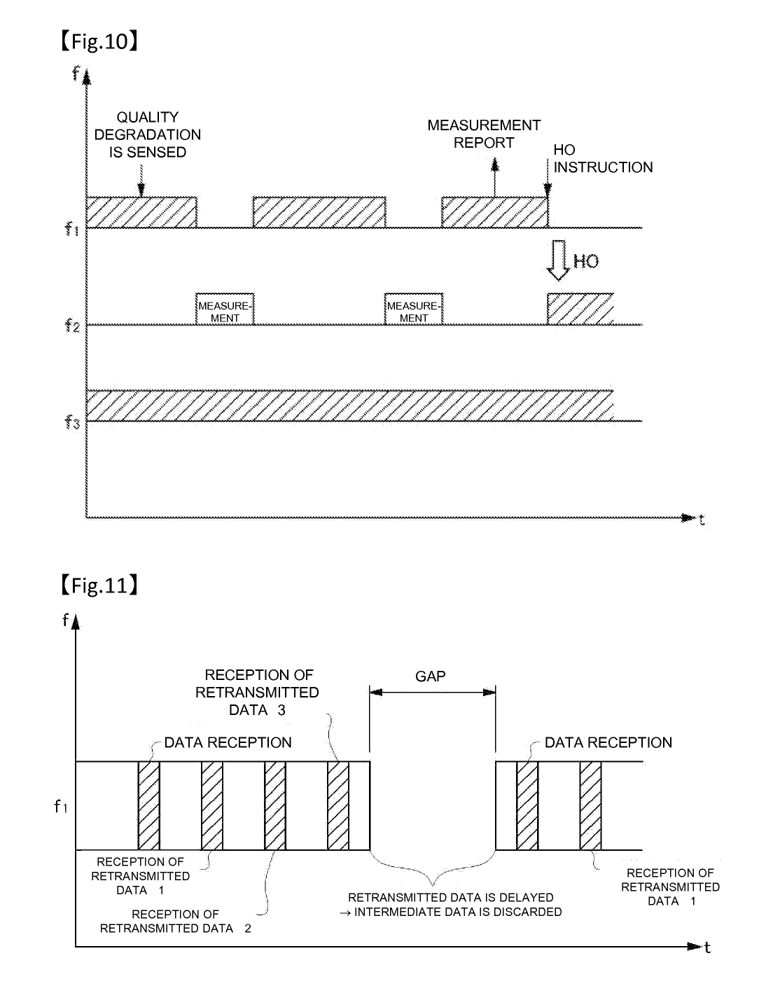

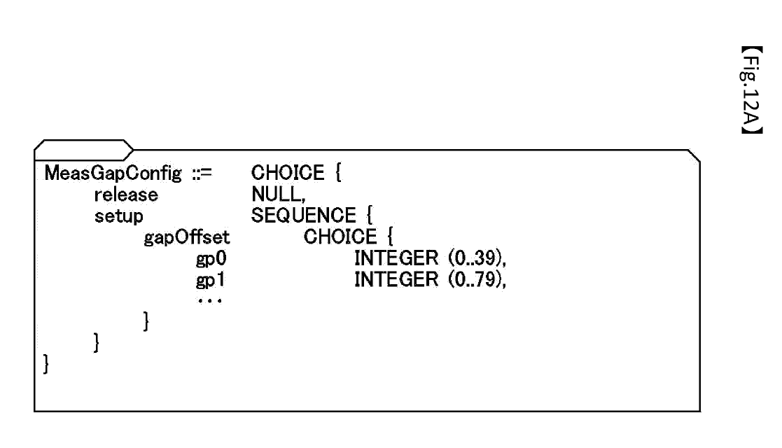

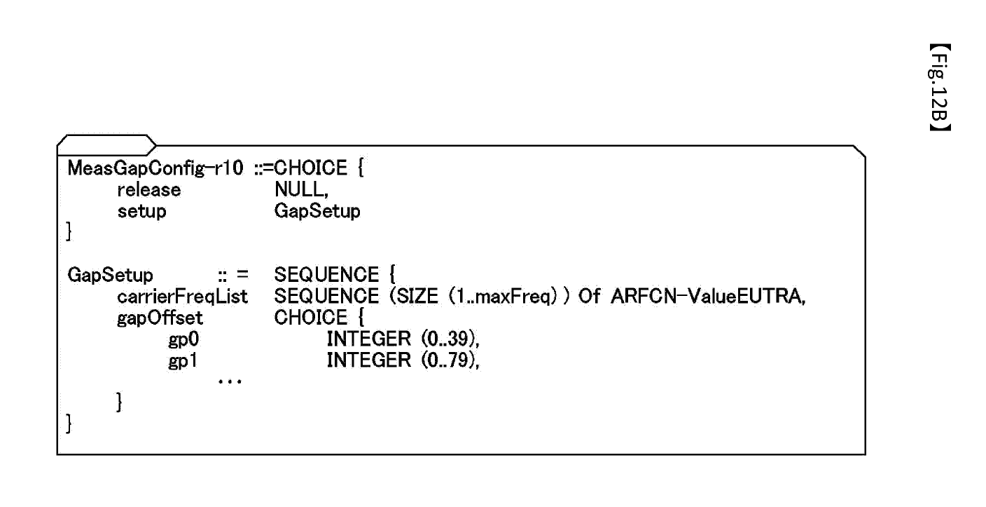

FIG. 7 is a diagram showing a timing of transmitting the request information to the base station 10 from the request transmitting unit 24. In the present embodiment, for example, the request transmitting unit 24 transmits the request information at a time point when the measurement result of the frequency being used is reported. At this time point, the request transmitting unit 24 transmits a request indicating which frequency the gap period is preferably provided at, if the measurement of the different frequency is performed in the future. The request transmitting unit 24 includes the request information to be notified, into an additional data field of a measurement result report message. Here, while an example is described in which the request transmitting unit 24 adds the request information to the measurement result report message, it may be defined that the request transmitting unit 24 transmits a new message which transmits the request information.

As shown in FIG. 6, the base station 10 has a request receiving unit 15 which receives the request from the mobile terminal 20. When receiving the request information transmitted from the mobile terminal 20, the request receiving unit 15 inputs the received request information into the gap period setting unit 14. The gap period setting unit 14 uses the inputted request information as a parameter, and configures the gap period in each band. It should be noted that the base station 10 has authority to configure the gap period. The gap period is not only configured based on the request from the mobile terminal 20. In addition to criteria of judgment as described in the above described first embodiment, the base station 10 takes into account the request from the mobile terminal 20 to determine the band in which the gap period is configured, and also to determine the arrangement of the gap period.

For example, if the two frequencies f1 and f3 have nearly equal quality, the gap period setting unit 14 may configure the gap periods in a cycle corresponding to twice the cycle in both bands to disperse the gap periods. Moreover, if the measurement is not completed in one gap period at a single frequency, the gap period setting unit 14 may concatenate the gap periods to be configured in both bands. In addition to such criteria of judgment as described in the first embodiment, if the base station 10 receives from the mobile terminal 20 the request information indicating that more gap periods are desired to be configured at the frequency f3 since voice communication is performed at the frequency f1 and data communication is performed at the frequency f3, for example, the gap period setting unit 14 may configure the gap periods corresponding to three times (the period, the frequency, or both of them of) the frequency f1, at the frequency f3. For example, if the base station 10 receives from the mobile terminal 20 the request information indicating that more gap periods are desired to be configured at the frequency f3 since four HARQ processes are operating at the frequency f1 and two HARQ processes are operating at the frequency f3, for example, the gap period setting unit 14 may configure the gap periods corresponding to twice (the period, the frequency, or both of them of) the frequency f1, at the frequency f3. In this way, since a reason why the frequency has been selected is transmitted along with the frequency at which the gap period is desired to be configured, the base station can appropriately select the frequency at which the gap period should be configured.

According to the present embodiment, the gap period is configured also in consideration of higher level information on the mobile terminal 20, such as content of the application and the status of the HARQ. While the base station 10 cannot discriminate the higher level information on the mobile terminal 20, the base station 10 can use the element such as the application which cannot be judged by the base station 10, to configure the gap period according to the present embodiment.

In the present embodiment, the example has been described in which the request information is used to request the frequency at which the gap period is configured, or the configuration method. However, it is also possible to previously define to indicate that the gap period is requested to be configured at the frequency which is used to notify the measurement result of the frequency being used. In this case, the mobile terminal provides the report of the quality measurement of the frequency f1 being used, by using the frequency side associated with f3, in order to notify that the gap period is desired to be configured at f3. In this method, the base station which is an object of the Band Aggregation needs to be identical, and association between a transmission frequency and a reception frequency of the mobile terminal needs to be comprehended. While a detailed association configuring method may need to be separately notified, it becomes possible to easily request the frequency at which the gap period is configured.

In the present embodiment, the example has been described in which the request from the mobile terminal, which is transmitted as the request information, is determined based on the number of the HARQ processes or the application being activated at the mobile terminal. However, in the above described first to third embodiments, content of the request can be determined by applying such criteria of judgment as performed by the base station. Moreover, it may be defined that the mobile terminal transmits the request information on a request showing which criterion of judgment in a plurality of the criteria of judgment described in the above described first to third embodiments is desired to be used to configure the gap period, to the base station.

In the present embodiment, the mobile terminal may transmit the request information through the band in which the gap period is desired to be configured in the request information.

It should be noted that the request information in the present embodiment may be information on the quality of the frequency. For example, a particular threshold is predetermined, and the mobile terminal can transmit the quality information on a frequency below the threshold, as the request information. Thereby, the base station can assign the gap to the frequency whose quality is below the predetermined threshold. Moreover, an operation is also conceivable in which a plurality of thresholds 1 and 2 are predetermined so that the threshold 1<the threshold 2, and if there is a frequency below the threshold 1, the mobile terminal transmits the quality of all frequencies below the threshold 2, as the request information. It should be noted that the plurality of thresholds 1 and 2 may be configured for the terminal by the base station, or may be previously determined. Instead of configuring both the threshold 1 and the threshold 2, a difference between the threshold 1 and the threshold 2 can also be configured.

### Fifth Embodiment

Next, the wireless communication system of a fifth embodiment of the present invention will be described. In the fifth embodiment, an example will be described in which the data transmission from the mobile terminal 20 to the base station 10 is performed. It is assumed that a retransmission timing of the HARQ has been cyclically defined.

The basic configuration of the wireless communication system of the fifth embodiment is the same as the wireless communication system of the first embodiment (see FIG. 1). In the present embodiment, the gap period is started each time the received data has become OK at a time point when the HARQ process has been completed, or at each time point when the sender has received the Ack. Thereby, it is possible to avoid a situation where the HARQ process is segmented by the gap period. However, normally, since there are a plurality of the HARQ processes being executed at one frequency, it is desirable to enable the gap period to be deterministically started by waiting until all the HARQ processes become OK, or previously defining the HARQ process to be prioritized, or providing an upper limit of time spent waiting until the HARQ processes become OK.

It should be noted that if the gap period is periodic, it may be determined which band the gap period is configured in. In this case, for example, it may be defined that it is determined which band the gap period is configured in, based on the number of Acks or Nacks transmitted or received immediately before. The gap period is provided at the frequency at which there are a large number of completed HARQ processes (there are a large number of Acks), in a plurality of the frequencies being used, at a time point when the Ack or the Nack is received. Thereby, even if the timing of the gap is predetermined, the gap period can be configured at the frequency at which the HARQ processes are less affected. It should be noted that the number of the Acks is information which can be commonly judged by the transmitter and the receiver, and thus, basically, the judgment may not be inconsistent between the base station 10 and the mobile terminal 20.

Moreover, if the Nack is received, it means that an ongoing HARQ process exists. Thus, it is conceivable that the less the number of the Nacks is, the less the number of the ongoing HARQ processes is, and the effect of the delay is small. Accordingly, the gap period may be provided at the frequency at which there are a small number of uncompleted HARQ processes (there are a small number of Nacks).

In the plurality of frequencies, the frequency is selected so that the gap period does not overlap a position where the Ack or the Nack should be transmitted and received. Thereby, a time in which the data remains in the buffer can be prevented from being increased because the Ack retards even though the HARQ is OK.

According to this configuration, not only a schedule of a first gap period but also a subsequent gap period which is configured at a time point when the HARQ process has been started can be optimized.

In the above description, the description assumes that the effect of the interrupt due to the gap period on the HARQ process being executed on the mobile terminal 20 side is reduced. However, if the mobile terminal 20 is transmitting data to the base station 10, the band in which the gap period is configured is determined so that the effect of the gap period on the HARQ process being executed at the base station 10 can be reduced. For example, the gap period may be configured in a band in which the HARQ process at the base station has become OK. Moreover, the gap period may be configured in a band in which a large number of HARQ processes have become OK at the base station.

### Sixth Embodiment

In the above described embodiment, regardless of an up-link or a down-link, the links can be mutually operated in parallel as the sender of the data and as the receiver of the data. In a sixth embodiment, a gap period configuring method in consideration that the up-link and the down-link are performed in parallel will be described. The basic configuration of the wireless communication system of the sixth embodiment is the same as the wireless communication system of the first embodiment.

It should be noted that, while the operation may be different between the up-link and the down-link depending on detailed configuring parameters for the HARQ or the gap period in the 3GPP, LTE, those skilled in the art can design those parameters or the like as appropriate if necessary.

In an access method in the present embodiment, the frequencies are divided into the up-link and the down-link. Thus, at a time point when the mobile terminal 20 connects to the cell configured by the base station 10, the mobile terminal 20 comprehends an up-link frequency for the transmission, which is associated with a down-link frequency for the reception. Normally, this down-link frequency and the up-link frequency are associated with each other. In this status, at least data transmission and the Ack/Nack for the data are communicated according to the above described association between the down-link frequency and the up-link frequency.

FIG. 8 is a diagram showing the association between the up-link and the down-link. In an example shown in FIG. 8, a down-link fd1 is associated with an up-link fu1, down-links fd2 and fd3 are associated with an up-link fu2, and a down-link fd4 is associated with an up-link fu3.

In the example shown in FIG. 8, when the gap period is configured in the down-link fd1, the communication of the Ack/Nack in the associated up-link fu1 is also stopped. Similarly, when the gap period is configured in the down-link fd2, the communication of the Ack/Nack in the associated up-link fu2 is also stopped, and as a result, the communication in the down-link fd3 is also delayed. In this way, if the gap period for the different frequency measurement is configured at the reception frequency of the mobile terminal 20, as a result, transmission of the Ack/Nack in the up-link is delayed, and furthermore, next data transmission in response to the Ack/Nack is also delayed.

Particularly, as shown in FIG. 8, in a status where the number of the down-link frequencies and the number of the up-link frequencies are asymmetric (for example, four down-link frequencies and three up-frequencies), if the gap period is configured in the up-link fu2 associated with many down-links, the number of the down-links which are accordingly delayed becomes large.

In the sixth embodiment, the gap period is configured while the up-link fu2 associated with many down-links is avoided. In this way, reduction of communication efficiency in the Band Aggregation can be suppressed in consideration of the association between the down-link frequencies and the up-link frequencies.

Hereinabove, the base station 10 and the mobile terminal 20 of the present invention have been described in detail with the embodiments. However, the present invention is not limited to the above described embodiments.

In the above described embodiments, various criteria of judgment for configuring the gap period have been described. However, criteria of judgment other than the above described criteria of judgment may be used to configure the gap period.

For example, the gap period may be configured based on the number of the HARQ processes being executed in each band. The number of the HARQ processes which are affected can be reduced by configuring more gap periods in the band with a smaller number of the HARQ processes.

The band may be selected depending on a length of the gap period required for the measurement. For example, there are the measurement objects in the gap period, for Measurement/for Inter-RAT/for CSG-ID check and the like. A time required for the measurement varies depending on the use, and moreover, a longer gap period is preferable for some measurement objects, and the gap period may be segmented into short periods so as to be dispersed, for some measurement objects. The band in which the gap period is configured may be selected depending on these measurement objects.

If the mobile terminal 20 is performing DRX (discontinuous reception), the timing of the gap period may be in accordance with a timing of a non-communication period in the discontinuous reception.

The band in which the gap period is configured may be selected depending on a processing cost required for switching to the frequency which is the measurement object (a time and power consumption required for switching the receiver and synchronization). For example, (1) the gap period may be configured at the frequency closer to the frequency which is indicated by the measurement object, (2) the gap period may be configured at the frequency from which the receiver can be easily switched to the frequency which is indicated by the measurement object, and (3) the gap period may be configured at the frequency in the same frequency band as the frequency which is indicated by the measurement object.

In the above described fourth embodiment, the example has been described in which the mobile terminal 20 transmits the request information related to the configuration of the gap period. However, the timing of transmitting the request information is not limited to the above described embodiment. For example, when the mobile terminal 20 connects to the base station 10, the mobile terminal 20 may transmit a default value of the request. The default value may be, for example, a rule indicating which gap period is configured depending on the reception quality.

The mobile terminal 20 may transmit the request information at a timing determined by the mobile terminal 20 for performing the quality measurement according to a predetermined criterion.

The mobile terminal 20 may request to switch from a conventional method of configuring the gap period at the degraded band (the band reported to have bad quality in a quality measurement report) to the method of the present invention, as the request information on the gap period. Thereby, the base station 10 can switch from the conventional method to the method of the present invention.

In the above described sixth embodiment, the example of the system has been described in which the frequencies are divided into the up-link and the down-link. However, forms of the up-link and the down-link are not limited to the above described embodiment. For example, in a case of a system in which the up-link and the down-link are temporally divided, in the frequencies at which the Band Aggregation is performed, if there is a frequency used only in the down-link, the frequency can be selected, or the frequency can be selected in consideration of the data transmission and the Ack/Nack transmission while the up-link and the down-link are considered as a whole.

### Seventh Embodiment

In the present embodiment, information on a CQI (Channel Quality Indicator) is used to determine the frequency to which the gap is assigned. The CQI is information which is provided by the terminal measuring the reception quality and notifying the base station of the frequency having good quality along with the quality, and which is used for performing scheduling by the base station. Here, the CQI can also be information indicating the quality of the entire frequency, or can also be information indicating the quality of only a part of the frequency. Here, the scheduling means that the base station dynamically assigns wireless resources for each terminal in order to cause a plurality of the terminals to efficiently transmit data.

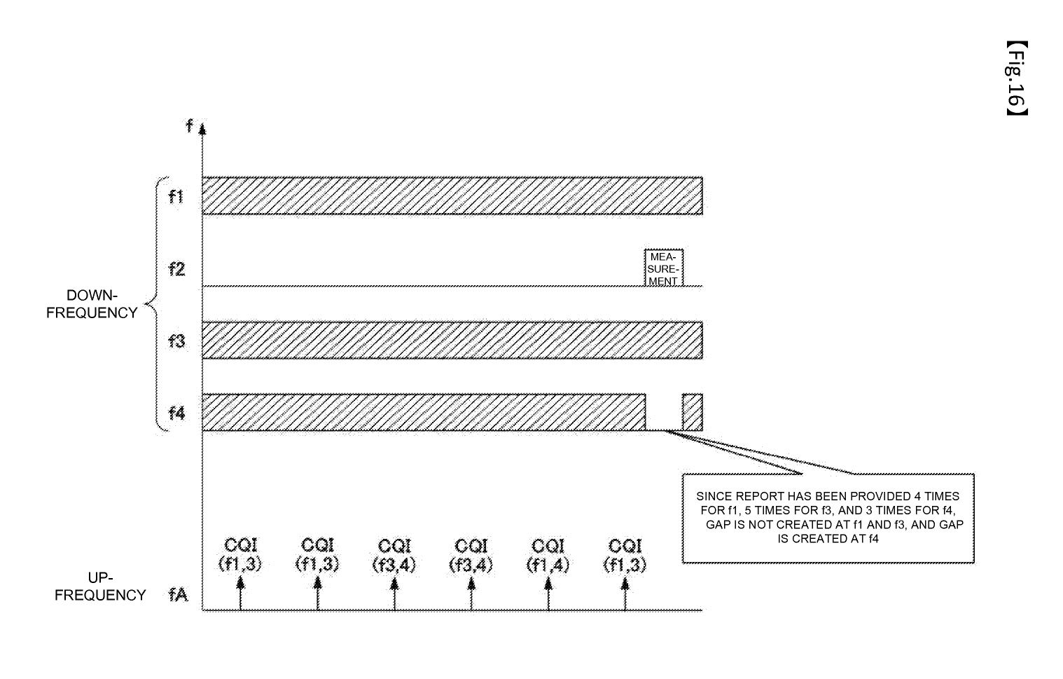

Here, it is conceivable to assign the gap to the frequency for which the terminal has not transmitted the CQI. Thereby, an operation is performed in which the base station does not perform the transmission at a position assumed to include the gap, at the frequencies other than the frequency for which the CQI has been received. Conversely, the base station can perform the scheduling without regard to the position of the gap, for the frequency for which the CQI has been received. FIG. 15 is a diagram showing a summary of an operation of configuring the gap by using the CQI. As shown in FIG. 15, if the base station has received a CQI report for the frequency f3, the base station does not configure a next gap at the frequency f3 but configures the next gap at the frequency f1. If the base station has received the CQI report for the frequency f1, the base station does not configure the next gap at the frequency f1 but configures the next gap at the frequency f3.

It should be noted that a failure to receive the CQI on the base station side is also conceivable. Thus, the judgment can also be made based on results of a plurality of the CQIs. A specific example is an operation in which the base station does not configure the gap at a frequency for which the CQI has been reported a particular number of times (for example, 4) or more, in a plurality of continuous CQIs (for example, 6). In such a case, since the scheduling may be performed for the frequency for which the CQI has been reported the particular number of times (in this example, 4) or more, the terminal does not assign the gap to the frequency, and assigns the gap to a frequency for which the CQI has been reported less than the particular number of times, and the like. FIG. 16 is a diagram showing a summary of another operation of configuring the gap by using the CQI. As shown in FIG. 16, the base station counts the number of times of the reception of the CQI report at each frequency within a predetermined period, and controls not to configure the gap at the frequency (in this example, the frequencies f1 and f3) for which the CQI has been reported four times or more. Moreover, if the CQI has been reported for all the frequencies, operations such as assigning the gap to a previously determined frequency, assigning the gap to the frequency for which the CQI has been reported the least number of times, and assigning the gap to the frequency having a lowest CQI report value are also possible.

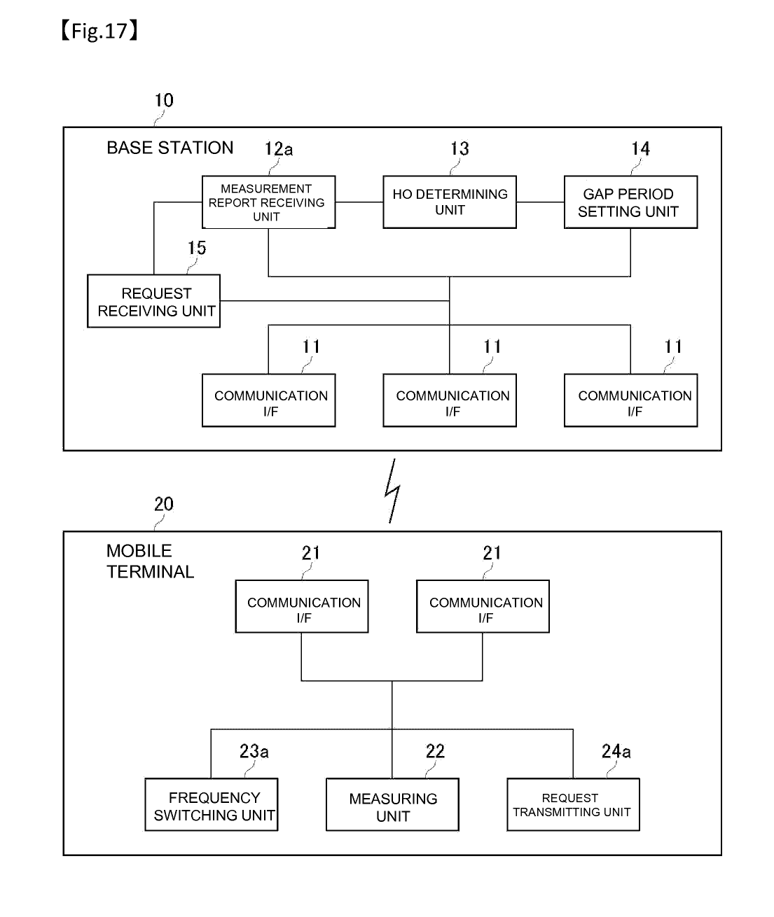

FIG. 17 is a diagram showing a block diagram in which the wireless communication system of the present embodiment is realized. While the basic configuration of the wireless communication system of the present embodiment is the same as the configuration of the wireless communication system of the fourth embodiment (see FIG. 6), an operation of a measurement report receiving unit 12a of the base station 10, as well as operations of a frequency switching unit 23a and a request transmitting unit 24a of the mobile terminal 20 are different.

The measurement report receiving unit 12a receives the CQI report from the mobile terminal 20, and determines the frequency at which the gap is configured, based on the CQI report. The operation of the measurement report receiving unit 12a is as described above. The request transmitting unit 24a has a function of creating the CQI and reporting the CQI to the base station 10 through the communication interface 21. The frequency switching unit 23a determines the frequency at which the gap is configured, based on a value of the CQI created by the request transmitting unit 24a. The operation of the frequency switching unit 23a is as described above.

In the above described embodiment, the various criteria of judgment for configuring the gap period have been described. However, the above described criteria of judgment may be combined to configure the gap period. For example, the base station can receive the request for the frequency at which the gap period is configured, based on an application being used, from the mobile terminal, and also, based on a threshold of a status of the quality degradation, reset the threshold by taking into account the request and determine the frequency at which the gap period is configured.

Each functional block used in the description of the above described embodiments of the present invention is typically realized as an LSI (Large Scale Integration) which is an integrated circuit. These functional blocks may be realized as individual chips, or may be realized as a chip comprising a part or all of the functional blocks. It should be noted that, while the LSI is mentioned here, the LSI may also be referred to as “IC (Integrated Circuit)”, “system LSI”, “super LSI” or “ultra LSI”, due to a difference in a degree of integration.

An approach for realizing the functional blocks as the integrated circuit is not limited to the LSI, and the functional blocks may be realized as a dedicated circuit or a general purpose processor. An FPGA (Field Programmable Gate Array) which is programmable after the LSI has been manufactured, or a reconfigurable processor in which connection and configuration of circuit cells within the LSI are reconfigurable may be used.

Furthermore, if any integrated circuit technology which replaces the LSI emerges through progress in a semiconductor technology or another derived technology, that technology may naturally be used to integrate the functional blocks. For example, application of biotechnology and the like may be possible.

Preferred embodiments of the present invention which are currently conceivable have been described above. However, various variations can be made to the present embodiments, and all such variations within the true spirit and scope of the present invention are intended to be comprised in the appended claims.

Followings are examples of other modifications of the above embodiments.

According to the base station of another aspect, the gap period setting unit may configure the gap period in a band in which a number of times of data retransmission to the mobile terminal has reached an upper limit.

According to the base station of another aspect, if there are a plurality of the bands in communication other than the band for which the handover is determined to be required, the gap period setting unit may configure the gap period in some bands in the plurality of bands.

According to the base station of another aspect, the gap period setting unit may configure the gap periods at a regular interval, and may configure the gap period in a band which has received an Ack immediately before a next gap period is configured, in the plurality of bands.

According to the base station of another aspect, the gap period setting unit may configure the gap periods at a regular interval, and may configure the gap period in a band in which an HARQ process at the base station has become OK immediately before a next gap period is configured, in the plurality of bands.

According to the base station of another aspect, the gap period setting unit may configure the gap periods at a regular interval, and may configure the gap period in a band in which a number of times of data retransmission has reached an upper limit immediately before a next gap period is configured, in the plurality of bands.

According to the base station of another aspect, the gap period setting unit may configure the gap periods at a regular interval, and may configure the gap period in a band which has received a large number of Acks since a previous gap period until a next gap period, in the plurality of bands.

According to the base station of another aspect, the gap period setting unit may configure the gap periods at a regular interval, and may configure the gap period in a band in which a large number of HARQ processes have become OK at the base station, in the plurality of bands.

According to the base station another aspect, the gap period setting unit may configure the gap periods at a regular interval, and may configure the gap period in a band which has received a small number of NAcks since a previous gap period until a next gap period, in the plurality of bands.

According to the base station of another aspect, the gap period setting unit may change the band in which the gap period is configured, depending on a degree of quality degradation in the band in communication.

According to the base station of another aspect, the gap period setting unit may store information on an association relationship between a down-link which transmits data and an up-link which returns a response to the data, and may configure the gap period in a band with which a small number of the down-links are associated, in the plurality of bands.

According to the base station of another aspect, the gap period setting unit may configure the gap period so that the gap period does not overlap a timing when the Ack or the Nack is transmitted and received.

According to the base station of another aspect may comprises: a request information receiving unit which receives request information related to the configuration of the gap period, from the mobile terminal, wherein the gap period setting unit configures the gap period by also using the request information.

A wireless communication system may comprise a base station above and a mobile terminal.

According to the mobile terminal of another aspect, the request transmitting unit may transmit the request information for requesting to configure the gap periods at a regular interval, and set the gap period in a band which has received a small number of Nacks since a previous gap period until a next gap period, in the plurality of bands.

According to the mobile terminal of another aspect, the request transmitting unit may transmit the request information for requesting to change the band in which the gap period is configured, depending on a degree of quality degradation in the band in communication.

According to the mobile terminal of another aspect, the request transmitting unit may transmit the request information for requesting to configure the gap period in a band with which a small number of down-links are associated, in the plurality of bands.

The mobile terminal according to claim 23, the request transmitting unit may transmit the request information for requesting to determine a ratio of the gap periods to be configured in the respective bands, based on a number of HARQ processes being executed at the mobile terminal in the communication in each of the plurality of bands, and set the gap periods in the determined ratio.

According to the mobile terminal of another aspect, the request transmitting unit may transmit the request information for requesting to determine a ratio of the gap periods to be configured in the respective bands, based on an application being executed at the mobile terminal through the communication in each of the plurality of bands, and set the gap periods in the determined ratio.

According to the mobile terminal of another aspect, the request transmitting unit may transmit the request information for requesting to determine a ratio of the gap periods to be configured in the respective bands, based on QoS information set for the communication in each of the plurality of bands, and set the gap periods in the determined ratio.

According to the mobile terminal of another aspect, the request transmitting unit may transmit the request information for requesting to configure the gap period in a band when an HARQ process at the mobile terminal in the band has become OK.

According to the mobile terminal of another aspect, the request transmitting unit may transmit the request information for requesting to configure the gap period in a band when a number of times of data retransmission of an HARQ process at the mobile terminal in the band has reached an upper limit.

According to the mobile terminal of another aspect, the request transmitting unit may transmit the request information for requesting to determine the band in which the gap period is configured, depending on a degree of quality degradation in the band in communication, and set the gap period in the band.

According to the mobile terminal of another aspect, the request transmitting unit may transmit the request information for requesting to obtain a band with which a small number of down-links are associated, in the plurality of bands, and set the gap period in the band.

According to the mobile terminal of another aspect, the request transmitting unit may transmit information on a band in which the gap period should be configured, and in addition, a reason why the band has been selected as an object in which the gap period is configured.

According to the mobile terminal of another aspect, the request transmitting unit may transmit the request information for requesting to configure the gap period so that the gap period does not overlap a timing when the Ack or the Nack is transmitted and received.

According to the mobile terminal of another aspect, the transmitting unit may transmit a quality measurement report of a frequency being used in a transmission frequency associated with a frequency at which the gap period is requested to be configured.

### INDUSTRIAL APPLICABILITY

As described above, the present invention has an advantageous effect that an effect of a communication interrupt due to the gap period can be reduced, and is useful as a base station which controls a Band Aggregation-enabled terminal.

### REFERENCE SIGNS LIST

10 base station
11 communication I/F
12 measurement report receiving unit
13 HO determining unit
14 gap period setting unit
15 request receiving unit
20 mobile terminal
21 communication interface
22 measuring unit
23 frequency switching unit
24 request transmitting unit

1. A base station, comprising:
a measurement report receiving unit which receives a measurement report transmitted from a mobile terminal which is performing communication by using a plurality of bands through Band Aggregation;
a handover determining unit which determines whether or not handover is required, based on the measurement report; and
a gap period setting unit which, if it is determined that the handover is required, temporarily interrupts the communication in a band in communication and configures a gap period, in order to search for a band which is a destination of the handover,
wherein the gap period setting unit also configures the gap period in the band in communication other than a band for which the handover is determined to be required.

2. The base station according to claim 1, wherein the gap period setting unit configures the gap periods so that the gap periods to be configured in the plurality of bands are continuous.

3. The base station according to claim 1, wherein the gap period setting unit configures the gap period only in the band in communication other than the band for which the handover is determined to be required.

4. The base station according to claim 1, wherein the gap period setting unit determines a ratio of the gap periods to be configured in the respective bands, based on a number of HARQ processes being executed at the mobile terminal in the communication in each of the plurality of bands, and configures the gap periods in the determined ratio.

5. The base station according to claim 1, wherein the gap period setting unit determines a ratio of the gap periods to be configured in the respective bands, based on a number of HARQ processes being executed at the base station in the communication in each of the plurality of bands, and configures the gap periods in the determined ratio.

6. The base station according to claim 1, wherein the gap period setting unit determines a ratio of the gap periods to be configured in the respective bands, based on an application being executed at the mobile terminal through the communication in each of the plurality of bands, and configures the gap periods in the determined ratio.

7. The base station according to claim 1, wherein the gap period setting unit determines a ratio of the gap periods to be configured in the respective bands, based on QoS information set for the communication in each of the plurality of bands, and configures the gap periods in the determined ratio.

8. The base station according to claim 1, wherein the gap period setting unit configures the gap period when an Ack has been transmitted from the mobile terminal.

9. The base station according to claim 1, wherein the gap period setting unit configures the gap period when an HARQ process on a side of the base station has become OK.

10-22. (canceled)

23. A mobile terminal which performs communication by using a plurality of bands through Band Aggregation, comprising:
a measuring unit which measures reception quality of the band being used for the communication;
a transmitting unit which transmits the reception quality measured in the measuring unit, as a measurement report; and
a request transmitting unit which, regarding a band in which the communication is temporarily interrupted and a gap period is configured in order to search for a band which is a destination of handover, transmits request information for requesting to configure the gap period in a band in communication other than the band which has become an object of the measurement in the measuring unit.

24. The mobile terminal according to claim 23, wherein the request transmitting unit transmits the request information for requesting to configure the gap periods so that the gap periods to be configured in the plurality of bands are continuous.

25. The mobile terminal according to claim 23, wherein the request transmitting unit transmits the request information for requesting to configure the gap period only in the band in communication other than a band for which the handover is determined to be required.

26. The mobile terminal according to claim 23, wherein the request transmitting unit transmits the request information for requesting to configure the gap period when an Ack has been transmitted from the mobile terminal.

27. The mobile terminal according to claim 23, wherein the request transmitting unit transmits the request information for requesting to configure the gap period in a band in which a number of times of data retransmission to the mobile terminal has reached an upper limit.

28. The mobile terminal according to claim 23, wherein if there are a plurality of the bands in communication other than a band for which the handover is determined to be required, the request transmitting unit transmits the request information for requesting to configure the gap period in some bands in the plurality of bands.

29. The mobile terminal according to claim 23, wherein the request transmitting unit transmits the request information for requesting to configure the gap periods at a regular interval, and set the gap period in a band which has received an Ack immediately before a next gap period is configured, in the plurality of bands.

30. The mobile terminal according to claim 23, wherein the request transmitting unit transmits the request information for requesting to configure the gap periods at a regular interval, and set the gap period in a band in which a number of times of data retransmission has reached an upper limit immediately before a next gap period is configured, in the plurality of bands.

31. The mobile terminal according to claim 23, wherein the request transmitting unit transmits the request information for requesting to configure the gap periods at a regular interval, and set the gap period in a band which has received a large number of Acks since a previous gap period until a next gap period, in the plurality of bands.

32-44. (canceled)

45. A gap period configuring method, comprising the steps of:
receiving a measurement report transmitted from a mobile terminal which is performing communication by using a plurality of bands through Band Aggregation;
determining whether or not handover is required, based on the measurement report; and
if it is determined that the handover is required, temporarily interrupting the communication in a band in communication and configuring a gap period, in order to search for a band which is a destination of the handover, and also configuring the gap period in the band in communication other than a band for which the handover is determined to be required.

46. A request transmission method for transmitting a request related to configuration of a gap, from a communication terminal which performs communication by using a plurality of bands through Band Aggregation, the method comprising the steps of:
measuring reception quality of the band being used for the communication;
transmitting the measured reception quality as a measurement report; and
regarding a band in which the communication is temporarily interrupted and a gap period is configured in order to search for a band which is a destination of handover, transmitting request information for requesting to configure the gap period in a band in communication other than the band which has become an object of the measurement in the measuring step.
